(19) United States
(12) Patent Application Publication
(10) Pub. No.: US 2007/0020589 A1
(43) Pub. Date: Jan. 25, 2007

(54) Electrothermal refreshable Braille cell and method for actuating same

(76) Inventors: Ethan Smith, Redondo Beach, CA (US); Erik Smith, Redondo Beach, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/399,131

(22) Filed: Apr. 5, 2006

Related U.S. Application Data
(60) Provisional application No. 60/668,809, filed on Apr. 6, 2005.

(51) Int. Cl. G09B 21/00

(52) U.S. Cl. 434/113

(57) ABSTRACT

An electrothermal actuated refreshable Braille cells, display systems using the cells, and methods for actuating refreshable Braille cells/displays. One method according to the invention comprises at least the following steps: a) providing power to a microheater within a cylinder, wherein the cylinder has a membrane at a first end and a microheater at a second end, and fluid in between; b) heating the fluid with the microheater, thereby causing it to expand; and c) allowing the membrane at the first end to bulge out, thereby forming a dot.

This application claims the benefit of U.S. Provisional Application Ser. No. 60/668,809 to Smith, filed on Apr. 6, 2005.

### BACKGROUND OF THE INVENTION

1. Field of the Invention

This invention relates to Braille cells, and more particularly to eletrothermal refreshable Braille cell apparatus and methods for actuating a refreshable Braille cell.

2. Description of the Related Art

Tactile display allows information to be communicated by stimulating a user's sense of touch and one method for communicating information in this way is by Braille. The user touches the Braille words, with the letters communicated through a series of bumps or dots. Refreshable Braille diplays contain tactile devices for the blind and partially sighted, translating text from systems, such as a computer, into readable characters. The display systems typically include two or more lines of Braille cells, each of which corresponds to a particular symbol (e.g. letter). Such systems are “refreshable” in that the display surface may be “wiped clean” and then can display another symbol. This allows for the sequential exhibition of different Braille letters.

The patent literature contains reports of several different methods that can be used to actuate, or form, a refreshable Braille cell. U.S. Pat. Publ. No. 20020106614, for instance, discusses a display system with a flexible surface. The system typically includes: a) a plurality of microelectromechanical valves having a top surface and a bottom surface; and b) a elastomeric polymer. In some forms, it uses piezoelectric devices or microelectromechanical shape memory alloy actuated devices in place of the microelectromechanical valves.

Another application, U.S. Pat. Publ. No. 20040175676, takes a different approach. This application is directed to the hydraulic actuation of a Braille dot using the bending characteristics of electroactive polymers. The bending mechanism is transferred to the linear motion of the Braille dot according to the report.

### SUMMARY OF THE INVENTION

The present invention provides a refreshable Braille cylinder, cell and display, and method for actuating a Braille cell that utilizes a medium or material that expands under heat to form a Braille dot. The Braille cell is not complex, can be fabricated using known methods, and provides for high volume production of refreshable Braille cells and displays.

One embodiment of a method for actuating a Braille cell according to the present invention comprises providing power to a microheater within a cylinder, wherein the cylinder has a membrane at one end, and a heat expandable medium. Heating the heat expandable medium with said heater, thereby causing it to expand. Bulging out the membrane under pressure from the expanding heat expandable medium, thereby forming a dot.

One embodiment of a Braille cell cylinder according to the present invention comprises a cylinder housing and a flexible membrane over one end of the cylinder housing. A heat expandable medium is within the cylinder housing; and a heater is arranged to heat the heat expandable medium causing the membrane to bulge out at the one end of said cylinder housing.

One embodiment of a refreshable Braille cell according to the present invention comprising a plurality of cylinder housings with a flexible membrane covering the openings at one end of the cylinder housings. A heat expandable medium is in each of said cylinder housings and a plurality of heaters is included, each of which is arranged to heat the heat expandable medium within a respective one of said cylinders. This causing expansion of the heat expandable medium, causing the flexible membrane at the respective one of the cylinders to bulge out to form a Braille dot.

One embodiment of a refreshable Braille display according to the present invention comprises a plurality of Braille cells arranged to allow a user to touch the surface of the cells. Each of the Braille cells comprises a plurality of cylinder housings with a flexible membrane covering the openings at one end of the cylinder housings. A mechanism is included for causing the flexible membrane at said respective one of the cylinders to bulge out to form a Braille dot.

### BRIEF DESCRIPTION OF THE DRAWINGS

FIG. 1 is a sectional view of one embodiment of an electrothermal cylinder according to the present invention that can be used in a refreshable Braille cell;

FIG. 2 is a sectional view of two electrothermal cylinders according to the present invention arranged in a refreshable Braille cell;

FIG. 3a is a sectional view of one embodiment of three Braille cells in a line according to the present invention;

FIGS. 3b is a sectional view of one embodiment of two Braille cells arranged in two different lines according to the present invention;

FIG. 4 shows a plan view of three Braille cells according to the present invention actuated for the word “and”;

FIG. 5 shows one embodiment of refreshable Braille computer screen method according to the present invention;

FIG. 6 shows another embodiment for actuating a refreshable Braille cell according the present invention;

FIG. 7 shows one embodiment of a method for presenting Braille text on a refreshable display according to the present invention; and

FIG. 8 shows one embodiment of a Braille touch screen method according to the present invention.

### DETAILED DESCRIPTION OF THE INVENTION

The present invention provides electrothermal actuated refreshable Braille cells, display systems using the cells, and methods for actuating refreshable Braille cells/displays. In general terms, Braille cells according to the present invention utilize cylinders, with each one of the cylinders corresponding to one of the dots in a Braille cell. Typical Braille cells contain six or eight dots arrayed in two columns. Each of the cylinders can be filled with a medium that expands under heat. Each of these cylinders further comprises a mechanism for applying heat to the medium, causing the medium to expand. Each of the cylinders also has a flexible material that deforms as the medium expands, with the flexible material forming a bump. This bump serves as one of the dots in a refreshable Braille cell. To form a particular Braille character, the desired ones of the six (or eight) dots in a Braille cell can be actuated by applying heat to medium in the desired cylinders. When the next character is to be displayed, heat can be applied to the desired cylinders to form the dots of that character.

A typical Braille display according to the present invention comprises a number of refreshable Braille cells arranged in one or more rows. Braille display systems can be used in any type of device that can be or is touched by the hand, and can be made to communicate or display tactily. The present invention is particularly adapted for use in computer displays, with the Braille cells being actuated under software control to communicate information through the Braille cells. As further described below, however, the refreshable Braille cells and display system according to the present invention can be used in many different applications beyond computer displays.

It will be understood that in describing the present invention, when an element or layer is referred to as being “on”, “connected to”, “coupled to” or “in contact with” another element or layer, it can be directly on, connected or coupled to, or in contact with the other element or layer or intervening elements or layers may be present. In contrast, when an element is referred to as being “directly on,” “directly connected to”, “directly coupled to” or “directly in contact with” another element or layer, there are no intervening elements or layers present. Likewise, when a first element or layer is referred to as being “in electrical contact with” or “electrically coupled to” a second element or layer, there is an electrical path that permits current flow between the first element or layer and the second element or layer. The electrical path may include capacitors, coupled inductors, and/or other elements that permit current flow even without direct contact between conductive elements.

It will also be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section without departing from the teachings of the present invention.

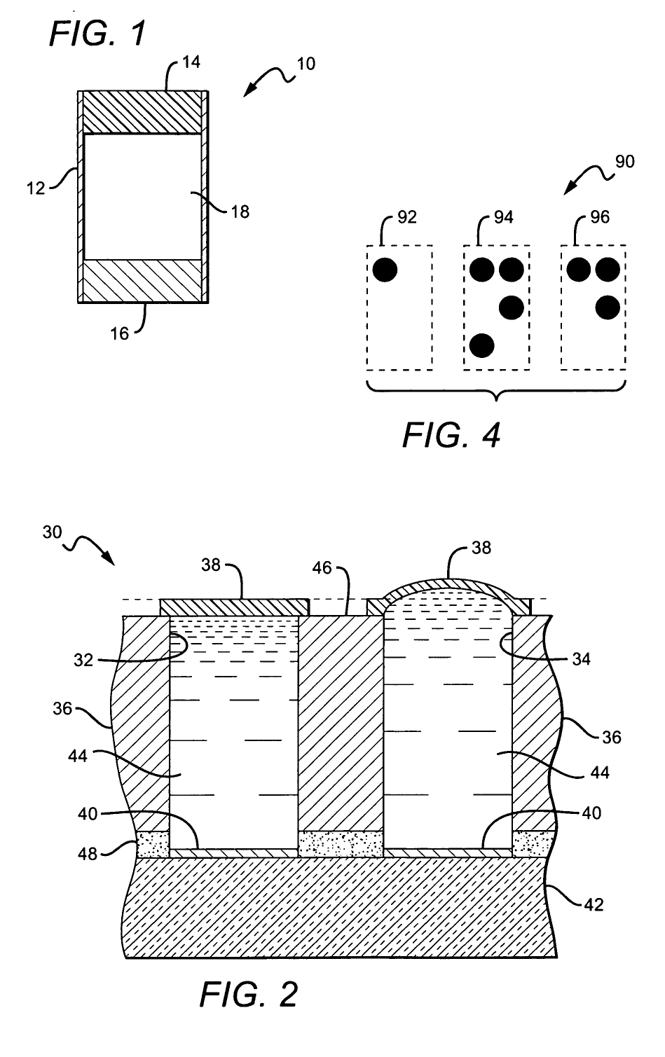

FIG. 1 shows one embodiment cylinder 10 that can be used in a Braille cell according to the present invention that can be combined with five (or seven) other similar cylinders to form a Braille cell. The cylinder comprises a cylinder housing 12 and a flexible membrane 14 over one open end of the cylinder housing 12. The flexible membrane 14 forms one of the dots of a Braille cell. The flexible membrane 14 can be made of many different materials but is preferably made of material having a low modulus of elasticity.

The cylinder 10 further comprises a heating mechanism 16, and in different embodiments according to the present invention, the heating mechanism 16 can be arranged in many different locations on the inside or outside of the cylinder housing 12. In the embodiment shown, the heating mechanism 16 is arranged in the opening of the cylinder housing 12 opposite the membrane 14. Many different heating mechanisms can be used, with a suitable heating mechanism 16 as shown being microheater on a substrate. The heating mechanism 16 generates heat in response to an electrical signal, with the substrate containing structures, such as conductive traces, that conduct an electrical signal to the microheater. The microheater may be similar to that described in the following publications that are hereby incorporated herein by reference: Grosjean et al., A Thermodynamic Microfluid System [Conference Paper], Technical Digest, MEMS 2002 IEEE International Conference, Fifteenth IEEE International Conference on Micro Electro Mechanical Systems (Cat. No. 02CH37266) IEEE 2002, pp. 24-27, Piscataway, N.J., USA; and Grosjean et al., Micro Balloon Actuators For Aerodynamic Control [Conference Paper] Proceedings MEMS 98, IEEE Eleventh Annual International Workshop on Micro Electro Mechanical Systems, In Investigation of Micro Structures, Sensors, Actuators, Machines and Systems (Cat. No. 98CH36176), IEEE, 1998, pp. 166-71, New York, N.Y., USA.

The cylinder housing 12 is at least partially filled with a medium 16 that expands under heat, such as a gas or a liquid, although it is understood that different materials can be used and that different combinations of materials can be used. When an electrical signal is provided to the heating mechanism 16, it heats the medium causing it to expand within the cylinder housing 12. All surfaces of the cylinder 10 contacting the medium are rigid except for the flexible membrane 14, such that the expanding medium causes the membrane 14 to bulge. This bulge serves as an actuated dot of the Braille cell.

When the electrical signal is removed from the heating mechanism 16, the medium 18 cools and contracts, and the membrane returns to its original position. The expansion 1 and contraction of the medium allows for the cylinder 10 and its Braille cell to be “refreshed”. This expansion and contraction of the medium under an electrical signal that causes heat, gives the cylinder 10 its electrothermal characteristics.

FIG. 2 shows first and second cylinders 32, 34 in one embodiment of a Braille cell 30 according to the present invention. The Braille cell also contains either an additional four or six cylinders, as the case may be, to form a complete Braille cell. Each of the cylinders is defined by a chamber wall 36, a membrane 38 and an microheater 40. The cylinders are arranged on a substrate 42 with each microheater 40 on the substrate at the base of the cylinder, and the chamber walls 36 bonded to the substrate 42. The microheater generates heat in response to an electrical signal and is preferably an electrode deposited on the substrate using known deposition methods such as sputtering, E-beam evaporation, or lift-off methods. In the lift-off method lithography is used to provide a pattern that is the reverse of the electrode pattern. Namely, the areas of the substrate not to be covered by the electrodes is covered by a photoresist. After metal deposition, the photoresist is dissolved in a acetone bath, leaving the electrodes covering the desired areas of the substrate. This allows the electrodes to be formed in the desired pattern without post deposition etching steps. In other embodiments according to the present invention, the substrate can comprise a printed circuit board.

A fluid (medium) 44 at least partially fills each of the cylinders 32, 34 with the fluid preferably filling substantially all of the cylinders 32, 34. Many different fluids can be used to fill the cylinders 32, 34 with preferred material being air or one or more phase change materials alone or in combination with other materials. A suitable phase change material is a paraffin wax that can include one or more paraffins. In the embodiment having a mixture of paraffins, the mixture can include n-paraffins, iso-paraffins and cycloparaffins, with n-paraffins typically being the predominant type. Paraffins used in the present can have a melting point range of approximately 10° C. or less. In certain cases, the melting point range is 5° C. or less, 4° C. or less, 3° C. or less or even 2° C. or less.

Paraffins used in the present invention typically begin melting above 35° C. Often times, they begin melting above 40° C., 50° C., or 60° C., 70° C. or higher. The use of paraffins including ≧90 percent of the same compound can be desirable. In some embodiments the use of paraffins including ≧95 percent of the same compound or ≧97 percent of the same compound is desirable. Paraffins used in the present invention may optionally include one or more antioxidants. A non limiting list of such antioxidants includes: vitamin E; vitamin C; BHA; and, BHT. Typically, the antioxidants are included at a weight/weight percentage of 1 percent or less. The Paraffin wax embodiment can be injected into the cylinders in its liquid state using known injection methods.

The membrane 38 is shown with separate membrane sections covering the top openings of the cylinders 32, 34. In other embodiments, the membrane can be one single piece covering the cylinder openings as well as the chamber wall mesas 46 as shown in phantom. As described above, the membrane is preferably made of flexible material having a low Young's modulus such as commercially available silicone and BCB (Cyclotene from Dow® Chemical). The membrane can be bonded in place over the cylinders using known bonding methods, such as spin coating.

The chamber wall and the substrate are preferably made of materials having low heat conductivity and are electrically insulating. Many different materials can be used such as glass, plastics, semiconductors and some ceramics. Silicon is also a suitable material in that microfabrication using silicon has been developed that can be applied to the present invention. In one embodiment using silicon, the chamber walls 36 are provided as a single wafer that can then be etched by DRIE (Bosch etch) to form the cylinder openings. For glass, etching processes can also be used, although it may be difficult to form straight chamber walls etching from glass. Cylinders can be formed in plastic using known fabrication methods. In still other embodiments the chamber wall and substrate can be made of a polymer, such as polycarbonate or PMMA. Alternatively, a thick photoresist, such as commercially available SU-8 can be used and photo-patterned to form the cylinders 32, 34. It is understood that many different materials can be used, and the cylinders can be formed in the materials using many different methods.

The cylinders 32, 34 can have many different diameters, with a suitable diameter being between 1.0 mm and 1.9 mm. Preferred cylinder diameters are between 1.4 and 1.6 mm, which correspond to the common dot base diameters for English based Braille cells. The cylinders can also have different depths, with a suitable depth being approximately 500 μm.

The substrate 42 can be made of many known materials, such as silicon, and can have conductive traces formed thereon using known methods. The traces conduct electrical signals to the electrodes (microheater) 40. The structure (wafer) forming the chamber walls 36 can be bonded to the substrate 42 by a bonding layer 48. The bonding layer can be a polymer adhesive, such as BCB (Dow® Chemical) or Overglaz (QQ 550, Dupont® Company). If the chamber wall wafer and/or substrate are made of glass, they can be bonded together using fusion bondng. If either or both are made of a photoresist or plastic, direct bonding methods can be used. It should be understood that the bonding method depends on the type of material selected for the substrate and chamber walls.

As shown, chamber 32 is not actuated. That is, its electrode 40 is not generating heat such that its fluid 44 is not expanding. Chamber 34, on the other hand, is actuated. Its electrode is being energized by an electrical signal to heat its fluid. This causes the fluid to expand and the membrane 38 to bulge over the cylinder opening. The desired membrane bulge is actuated by controlling which electrode is energized. The desired electrodes can be energized using known methods, with the electrodes 40 deposited on the substrate 42 with interconnecting traces to allow each electrode to be separately energized. This type of electrode and trace interconnection is known.

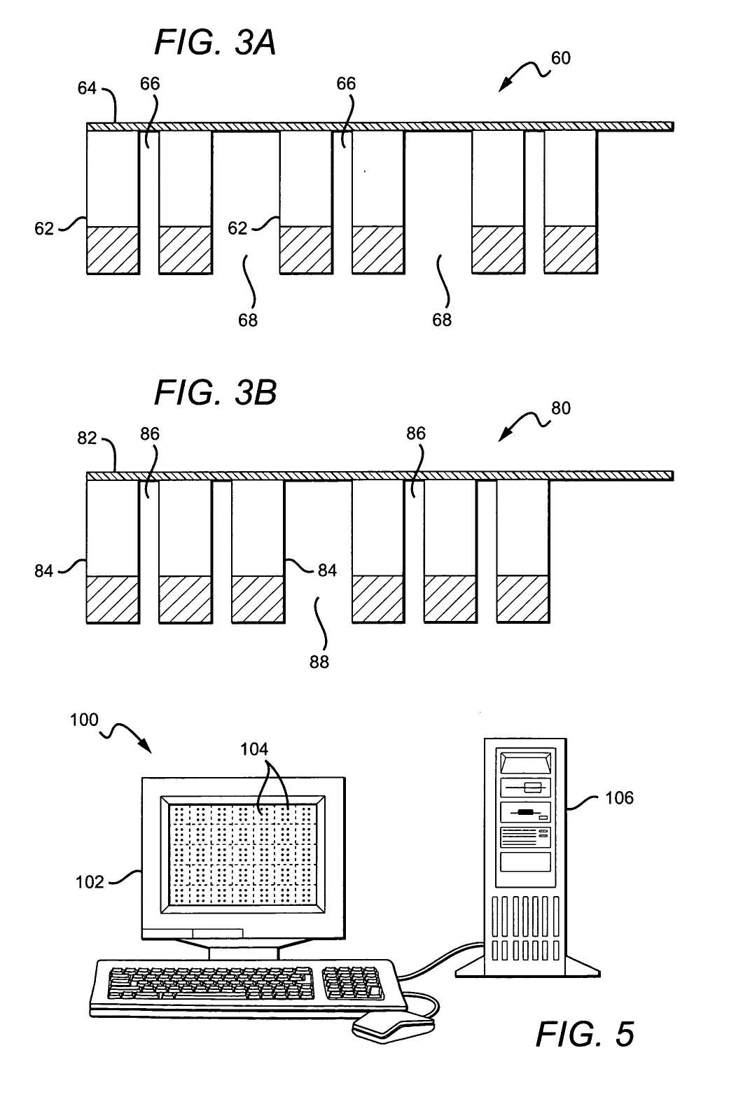

FIG. 3a shows a sectional view of one embodiment of three Braille cells 60 according to the present invention arranged in a line. Each Braille cell typically comprises six (6) cylinders 62, although only two cylinders in each cell are shown. A continuous membrane 64 covers the cylinders. Within each cell, space 66 between cylinders 62 as shown is typically between 2.03 and 3.25 mm, although other spaces can also be used. Preferred horizontal spaces within a cell are between 2.2 and 2.54 mm. The space between adjacent Braille cells in a line 68 is typically between 2.5 mm and 6.53 mm, with the preferred space between cells being between 3.81 mm and 5.42 mm.

FIG. 3b shows a sectional view of two Braille cells 80 according to the present invention that are arranged in two different lines. A continuous membrane 82 again covers the cylinders 84. Spaces 86 between the dots within a Braille cell are approximately the same dimensions as spaces 66 in FIG. 3a. The space 88 between adjacent Braille cells are approximately the same dimensions as spaces 68 in FIG. 3a.

FIG. 4 shows one embodiment of three Braille cells 90, 92, 94 having cylinders that have been actuated to bulge the desired membrane. On dot (bulged membrane) appears in cell 92, which corresponds to the letter “a”; four dots appear in cell 94, which correspond to the letter “n”; and, three dots appear in cell 96, which correspond to the letter “d”. The combination of the three Braille cells forms the word “and”. Each of the Braille cells can be refreshed and form the dots to a different letter by removing the energy from the cylinders and then energizing the desired cylinders to form the desired dot pattern.

FIG. 5 shows one embodiment of computer display system 100 utilizing refreshable Braille cells according to the present invention. The system 100 comprises a computer display 102 having multiple refreshable Braille cells 104 arranged in the desired rows to allow the user to touch the surface of the cells 104. The display 102 is coupled to controller 106 that provides the necessary electrical signals to cause the desired dots (membrane bulges) to form at the Braille cells 104. The controller 106 can be many different devices, such as a known personal computer (PC). The Braille cell control signals transmitted to the computer display 102 can be generated using different software approaches. One is to have an operating system on the controller specifically designed to generate the Braille cell control signals. This can include known Windows®, Linux or Macintosh operating systems on a PC, or independently developed operating systems on a PC or other platform. Another approach would allow the existing operating system such as Windows® or Linux, Macintosh, or other operating system to work with translation software that translates the typical visual output to binary or Braille cell output. This allows a standard Window® screen to be translated so that only the outline of Windows® and outline of its Icons would be displayed with Braille text instead of Ascii test. For both software approaches, signals would be sent to individual cells to control which dots are actuated.

Braille cells according to the present invention can be used in many applications beyond computer displays. For example, the cells can be used on the steering wheel of an automobile that has the points raise to cue the driver of an emergency. The cell could be used on a hand held device carried by military, firefighters, or whomever may be working in a low or zero-visibility environment. Any kind of device that can be touched by the hand can be made to communicate or display tactily.

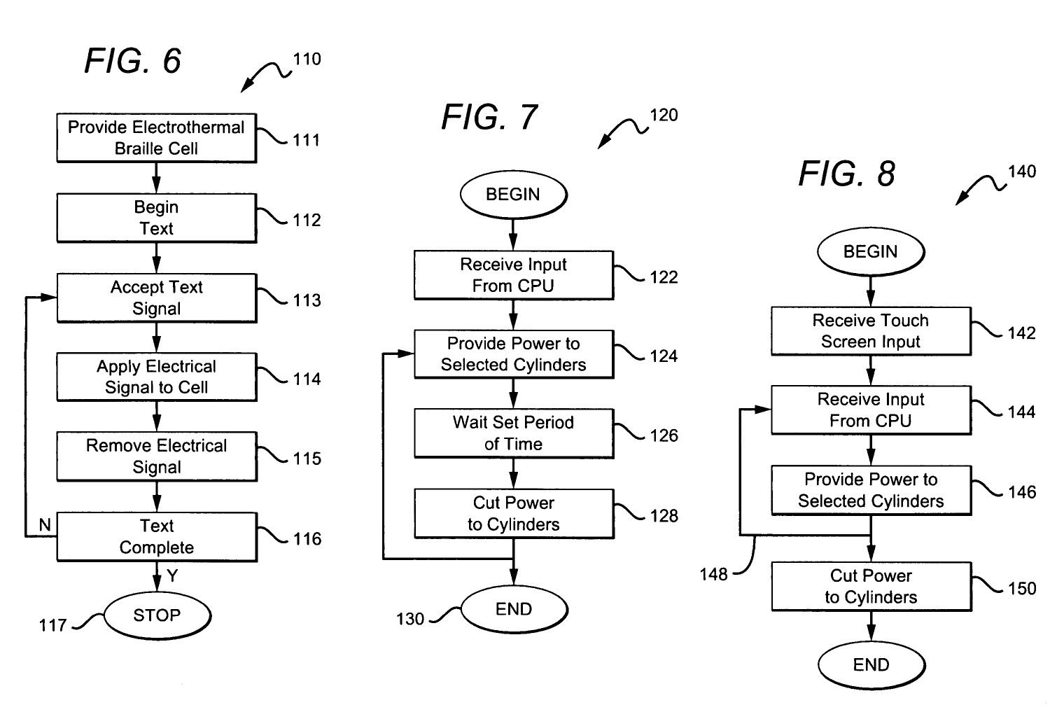

FIG. 6 shows one embodiment of a method 110 for forming Braille characters in a Braille cell according to the present invention. Although method 110 is described in series of steps, it is understood that the method steps can be in different order and can have different steps. In step 111, an electrothermal activated Braille cell is provided, and in a preferred method the Braille cell comprises cylinders having an medium that expands under heat, a microheater, and a membrane similar to those shown in the figures and described above. In step 112, text begins that is to be displayed by the Braille cell. In step 113, a signal (message) is accepted having the information to activate the desired ones of the Braille dots in the Braille cell. This signal can originate from the operating system of a PC as described above. In step 114, an electrical signal is applied to the desired ones of the Braille dots to be activated. This causes the microheater to heat the medium within the particular cylinder, which in turn causes the membrane to bulge forming a raised dot. In step 115, after a predetermined amount of time, the electrical signal is removed from the Braille cell, causing the medium to cool and contract and causing the membrane to return to its original position over the cylinder. This is the refresh state of the Braille cell.

In step 116, if the text that is to be displayed is complete, the method stops 117. If, however, there is more text to be displayed, the method returns to step 113 and accepts another signal for displaying another character. This continues until the text is complete.

FIG. 7 shows another embodiment of a method 120 for using the present invention in a refreshable Braille display, and although this method is described in a series of steps, it is understood that the method steps can be in different order and can have different steps. Input is received from a CPU in step 122, and power is provided to select cylinders that correspond with the input at step 124. A set period of time is allowed to pass in step 126, and power is then cut to the cylinders in 128. This either signals the end of the display material 130, or the need to begin the process again.

In certain cases, the refreshable Braille display system of the present invention includes a touch screen where the Braille cells are activated only in the area touched by the user's fingers. This can include the cells directly under the fingers or in the areas under and around the fingers. The touch screen can be part of membrane 64 described above and shown in FIG. 3a, or can comprise a material layered on top of membrane 64. Different touch screen systems and methods can be used according to the present invention, including but not limited to, capacitive-based, resistive-based, infrared-based and surface acoustic wave-based systems and methods. See, for example, U.S. Pat. No. 6,741,237, which is incorporated-by-reference for all purposes.

FIG. 8 shows one embodiment of method 140 for using the touch screen version of the present invention. As the result of a person's touch, input is received by the CPU 142. The input includes the location of the person's touch on the screen, as well as the area of the touch. After receiving the input, the CPU correlates it with information related to display content; further input is sent by the CPU 144, and power is provided to select cylinders that correspond with the input 146. Power is provided until the person moves his finger from its original location on the touch screen. If the finger glides along the surface of the touch screen, it will induce power to be provided to other, select cylinders 148 while cutting power to the originally activated cylinders 150. If the finger is removed from the surface of the touch screen, power to cylinders will simply be cut 152.

The number of cylinders receiving power as the result of a single touch varies. Typically, at least the number of cylinders associated with a single character (i.e., a single Braille cell) will be activated. In certain cases, cylinders associated with multiple characters (e.g., 2, 3, 4 or 5 Braille cells) will be activated. The activated cylinders, or Braille cells, typically relate to the same line of text on the display.

Although the present invention has been described in considerable detail with reference to certain preferred configurations thereof, other versions are possible Therefore, the spirit and scope of the appended claims should not be limited to their preferred versions contained therein.

We claim:

1. A method for actuating a Braille cell, comprising:
providing power to a microheater within a cylinder, wherein the cylinder has a membrane at one end, and a heat expandable medium;
heating said heat expandable medium with said microheater, thereby causing it to expand; and
bulging out said membrane under pressure from said expanding heat expandable medium, thereby forming a dot.

2. The method according to claim 1, wherein the Braille cell is fabricated on a silicon or plastic substrate.

3. The method according to claim 1, wherein the Braille cell is fabricated on a polymer substrate.

4. The method according to claim 3, wherein said polymer substrate is polycarbonate or PMMA.

5. The method according to claim 1, wherein said heater is a microheater patterned on a printed circuit board.

6. A method for providing a refreshable Braille display, comprising:
receiving input from a central processing unit;
providing power to cylinders corresponding to the input, wherein each of said cylinders comprises a membrane and a heat expandable medium, said power causing said heat expandable material to bulge out its respective membrane;
waiting a set period of time; and
cutting power to the cylinder microheaters, thereby refreshing a display.

7. A Braille cell cylinder, comprising:
a cylinder housing;
a flexible membrane over one end of said cylinder housing;
a heat expandable medium within said cylinder housing; and
a heater arranged to heat said heat expandable medium causing said membrane to bulge out at said one end of said cylinder housing.

8. The cylinder of claim 7, wherein said heater comprises a microheater at the end of said cylinder housing opposite said membrane, said microheater generating heat in response to an electrical signal.

9. The cylinder of claim 7, wherein said heat expandable medium is arranged between said microheater and said membrane.

10. The cylinder of claim 7, wherein said heat expandable medium comprises a phase change material.

11. The cylinder of claim 10, wherein said phase change material comprises a one or more paraffin waxes alone or in combination with other materials.

12. A refreshable Braille cell, comprising:
a plurality of cylinder housings;
a flexible membrane covering the openings at one end of the cylinder housings;
a heat expandable medium in each of said cylinder housings; and
a plurality of heaters each of which is arranged to heat said heat expandable medium within a respective one of said cylinders causing its expansion, said expansion 10 causing said flexible membrane at said respective one of said cylinders to bulge out to form a Braille dot.

13. The Braille cell of claim 12, wherein each said heater comprises a microheater at the end of a respective one of said plurality of cylinder housings opposite to said membrane, each said microheater generating heat in response to an electrical signal.

14. The Braille cell of claim 13, wherein an electrical signal is applied to the desired ones of said microheaters to form a Braille character with said bulging out membrane.

15. The Braille cell of claim 12, wherein said heat expandable medium in each of said cylinder housings is arranged between its respective said microheater and said membrane.

16. The Braille cell of claim 12, wherein said heat expandable medium comprises a phase change material.

17. The Braille cell of claim 16, wherein said phase change material comprises a one or more paraffin waxes alone or in combination with other materials.

18. A refreshable Braille display, comprising:
a plurality of Braille cells arranged allow the user to touch the surface of the cells, each of said Braille cells comprising:
a plurality of cylinder housings;
a flexible membrane covering the openings at one end of the cylinder housings; and
a mechanism for causing the flexible membrane at said respective one of said cylinders to bulge out to form a Braille dot.

19. The Braille display of claim 18, further comprising a heat expandable medium in each of said cylinder housings and a plurality of heaters each of which is arranged to heat said heat expandable medium within a respective one of said cylinders causing its expansion, said expansion causing said membrane to bulge out.

20. The Braille display of claim 18, comprising a computer screen.

21. The Braille display of claim 18, wherein each of said Braille cells can be activated to form a Braille character.

22. The Braille display of claim 21, wherein each of said Braille cells is activated by electric control signals.

23. The Braille display of claim 22, wherein said electric control signals are generated by an operating system on a PC or handheld devide.

24. The Braille display of claim 18, wherein each said heater comprises a microheater at the end of a respective one of said plurality of cylinder housings opposite to said membrane, each said microheater generating heat in response to an electrical signal.

25. The Braille display of claim 24, wherein an electrical signal is applied to the desired ones of said microheaters to form a Braille character with said bulging out membrane.

26. The Braille cell of claim 18, wherein said heat expandable medium in each of said cylinder housings is arranged between its respective said microheater and said membrane.

27. The Braille display of claim 18, wherein said heat expandable medium comprises a phase change material.

28. The Braille display of claim 27, wherein said phase change material comprises a one or more paraffin waxes alone or in combination with other materials.
